(19) United States
(12) Patent Application Publication
(10) Pub. No.: US 2024/0351141 A1
(43) Pub. Date: Oct. 24, 2024

(54) METHOD FOR PRODUCING A BODY OR A BODY PART OF A MOTOR VEHICLE

(71) Applicant: AUDI AG, Ingolstadt (DE)

(72) Inventors: Tobias BRAUN, Cleebronn (DE); Thorsten BUßMANN, Heilbronn (DE); Daniel RUDOLPH, Heilbronn (DE)

(73) Assignee: AUDI AG, Ingolstadt (DE)

(21) Appl. No.: 18/639,024

(22) Filed: Apr. 18, 2024

(30) Foreign Application Priority Data
Apr. 20, 2023 (DE) 102023110007.6

(51) Int. Cl. B23K 26/24; B62D 27/02

(52) U.S. Cl. CPC B23K 26/24; B62D 27/023

(57) ABSTRACT

A method for producing a body or a body part of a motor vehicle. The body or the body part includes multiple components made of metal, which are welded to one another in adjacent connection regions via welding points or welding seams. A welding point or a welding seam is applied to the component at one or more positions outside the connection regions, to locally reduce the strength of the metal.

### FIELD

The invention relates to a method for producing a body or a body part of a motor vehicle, wherein the body or the body part is formed from multiple components made of metal, which are welded together at adjacent connection regions via welding points or welding seams.

### BACKGROUND

A complete body or a correspondingly large body part of a motor vehicle is regularly assembled from multiple individual metal components, wherein multiple body parts are finally assembled to form the body. The components are positioned accordingly relative to one another so that they are arranged next to one another or adjacent to one another with an appropriate joint, be it a butt joint or an overlap joint or a T-joint. The individual metal components are connected in the adjacent connection regions by welding, wherein the connection is made either via a corresponding number of welding points or longer welding seams.

In order to enable deformation of the body in defined regions in the event of a collision of the motor vehicle, a targeted, local softening of the material of the component, i.e. the metal, is carried out in these regions. The body is usually produced from components made of high-strength steel, wherein the metal is hardened throughout and has a hardness of, for example, HV 400-520. In order to soften the region of the component, i.e. to reduce the hardness, heat is introduced locally during the production of the respective component, namely that a targeted heat treatment of the component takes place in defined local regions. The heat input can take place, for example, using a laser or a thermal printer or the like and is carried out by the manufacturer of the metal component. If the metal components are then connected to one another by the body manufacturer to form the complete body or the larger body part, the body or the body part has a reduced hardness in the treated regions that lie outside the connection regions of the components to one another, that is, a local softening is provided. This type of production of the regions with reduced hardness is complex, since the component manufacturer must have appropriate system technology such as a laser or similar and the corresponding heat treatment process must be carried out.

### SUMMARY

The object of the invention is to specify a correspondingly improved method.

To achieve this object, in a method of the type previously mentioned, it is provided according to the invention that a welding point or a welding seam is applied to the component at one or more positions outside the connection regions to locally reduce the strength of the metal.

In the method according to the invention, the local strength reduction, i.e. the softening, is carried out by the manufacturer producing the body or body part. This is because the manufacturer has the appropriate welding technology with which he welds the individual metal components together to form the finished body or body part. This joining technology is now used not only for the component connection, but also for the local strength reduction by using the same joining tool, i.e. a suitable welding robot or similar, to locally introduce heat into the defined region or regions of the body or body component by applying a welding point or a welding seam on the welded component, wherein the originally hardened structure is tempered via this local heat input and the hardness is thus decreased. A spot-shaped or elongated or bead-shaped welding application thus takes place on the surface of the component or, if all components have already been welded together to form the body or the body part, on the respective surface. This makes it possible to reduce the hardness accordingly, for example from the original HV 400-520 to a hardness of, for example, HV 220-270. As a result of this local reduction in hardness, the body or the body component deforms preferably in this or these regions, when a force is applied thereto, wherein these regions are of course provided at non-critical points of the body or the body component.

The invention therefore provides for the use of an existing joining device or welding device, which is provided by the body manufacturer and is used to weld the components to form the body or body part, for additional local softening, thus for forming the hardness-reduced regions. The required degree of strength can be adjusted accordingly via this heat treatment, as can the size or shape of the softened region.

For this local heat input, almost any welding tool for welding the components can be used. The heat input via the welding application and thus the softening can be achieved by laser welding, arc welding, inert gas welding such as metal inert gas welding (metal active gas welding (MAG) or metal inert gas welding (MIG)), tungsten inert gas welding (TIG) or plasma welding, although the list is not exhaustive or limiting.

In order to be able to soften a correspondingly large region, it is conceivable that multiple welding points and/or welding seams are applied adjacent to one another. By placing multiple welding points or welding seams in a corresponding neighborhood, a respective local heat input takes place over a correspondingly larger region, so that overall a correspondingly large, heat-treated region is obtained, in which the strength is reduced. A corresponding welding application is carried out at multiple positions on the surface of the component or the body or body parts that have already been welded together.

If an elongated region is to be formed, multiple welding points can be applied in a line during welding application, so that the linear welding point sequence results in a correspondingly elongated region of educed strength. It is also conceivable to apply a correspondingly long welding seam, i.e. a weld bead of correspondingly long shape.

If the portion of the body or body part on which local softening is to take place at one or more points is designed as a support, the multiple welding points or the welding seam can be arranged around the periphery, i.e. in a completely surrounding manner, so that a corresponding large peripheral region is softened. Alternatively, it is also conceivable that the multiple welding points or the welding seam are arranged only in portions running around the periphery. Here, as viewed around the periphery, a softened region is provided, which is peripherally followed by a correspondingly strong region. While in the first variant there is a deformation point extending around the entire periphery, in the second variant there is only a local deformation point.

If a linear shape is applied over the welding application, be it multiple welding points or a correspondingly long welding seam, this linear shape can have virtually any geometry. The line can be straight. Alternatively, the line can also be curved, for example circular or spiral or wavy or similar. An angled line can also be created, which can be angled once or multiple times in the manner of a zigzag pattern or the like. This offers the possibility of designing the shape of the softened region according to requirements.

In addition to the method, the invention also relates to a body or a body part, produced according to the method described above.

The invention further relates to a motor vehicle, comprising a body or a body part, which is produced using the method described above.

### BRIEF DESCRIPTION OF THE FIGURES

Further advantages and details of the present invention will be apparent from the exemplary embodiments described below and in reference to the drawings. In particular:

FIG. 1 is a schematic representation of a partial view of a body or a body part according to the invention with multiple regions softened by welding points and a welding seam, and

FIG. 2 is a schematic representation of a partial view of a body or a body part according to the invention with further softened regions which are formed by other welding point arrangements or welding seam arrangements.

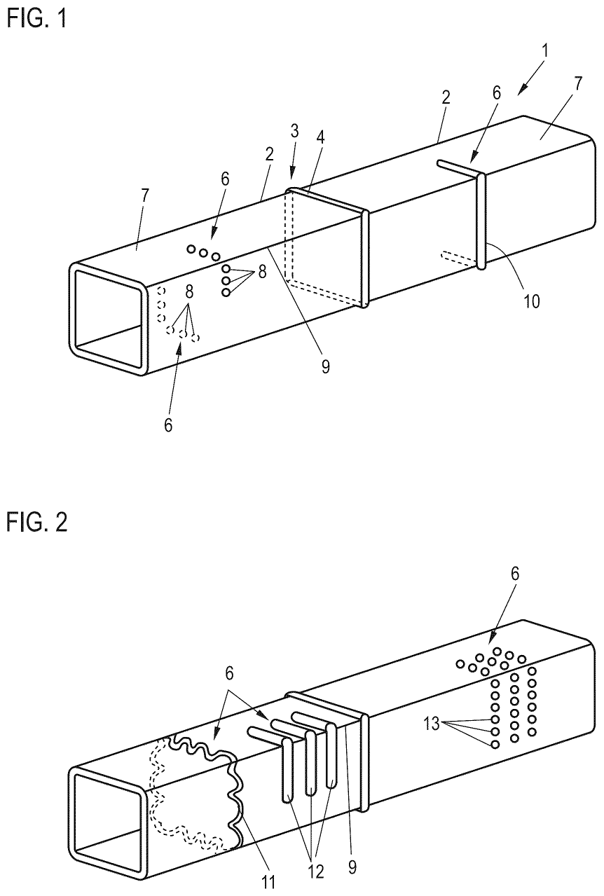

FIG. 1 shows a partial view of a body 1 according to the invention, which can also be a body part. The body 1 consists of multiple metal components 2, which are welded together in a connection region 3 via a surrounding welding seam 4 in the region of their joint, which in this case is a butt joint. The components 2 are made of metal, usually a high-strength steel, for example with a Vickers hardness HV of 400-520. In order to locally reduce this hardness in order to enable targeted deformation in the event of a collision in specific regions, to meet crash requirements, in the example shown two different welding applications 6 are applied to the top side 7 of the two components 2, preferably after they have already been connected to one another via the welding seam 4. The welding seam 4 and the welding applications 6 are formed using the same welding robot, which can operate with different welding methods, for example a metal active gas welding or metal inert gas welding or similar.

The welding application 6 shown on the left is formed by a plurality of individual welding points 8, which are applied along a line on the surface 7 and which run around the edge 9 of the part, which in this case is designed as a support. As shown by the dotted welding points 8, a corresponding welding application 6 is also provided on the opposite side. As a result of these welding point lines, two defined regions are heat treated after the welding or welding application is carried out at a high temperature, which heats the metal base material of the component 6, so that a tempering effect occurs in this position and the metal structure is softened. A corresponding linear region of reduced hardness is formed, wherein the hardness can be adjusted by corresponding selection of the welding parameters, while the size of the region can be adjusted by corresponding selection of the size of the welding points 8 or the arrangement thereof. The hardness in the softened region should be between HV 220-270, for example.

The welding application 6 shown on the right is formed via a linear welding seam 10 that runs in portions around the periphery of the component 2 or the body portion, i.e. a bead-shaped welding application. Here, too, there is an elongated, almost linear softened region, which is not only immediately provided below the welding application 6, but also extends somewhat in width due to the heat input.

FIG. 2 shows various variants of further forms of welding applications 6. The welding application 6 shown on the left is formed via a wave-shaped welding seam 11 that runs around the entire periphery, wherein the range of temperature input can be broadened accordingly via this wave shape.

In contrast, the central welding application 6 is formed via three separate welding seams 12, which are drawn over the edge 9, wherein the welding seams 12 are relatively close to one another, so that their respective temperature inputs virtually overlap and, as a result, a correspondingly wide softened region is formed.

Such a relatively wide region can also be formed by multiple individual welding points 13, which are applied in the form of individual lines close to one another, as shown by the welding application 6 shown on the right in FIG. 2.

The welding application geometries shown are merely exemplary in nature and not limiting. The respective welding application form, i.e. point-shaped or linear as a seam or bead, is selected according to the given crash requirements, which define on the one hand the position of a softened region and on the other hand the region size and region geometry, and the existing connection technology.

A body manufactured in this way is part of a motor vehicle and forms the central, supporting structure. By forming corresponding defined deformation regions through the local softening of the hardened steel, it is achieved that in the event of a collision the body preferably deforms or buckles exactly in these softened regions in order to dissipate energy, which is beneficial for occupant protection. With the method according to the invention, such softened regions can be produced in a simplified manner, since they are created virtually at the same time as the body construction using a welding unit or welding robot that is also used for body construction.

1. A method for producing a body or a body part of a motor vehicle, wherein the body or the body part is formed from multiple components made of metal, which are welded together at adjacent connection regions via welding points or welding seams, wherein a welding point or a welding seam is applied to the component at one or more positions outside the connection regions for locally reducing the strength of the metal.

2. The method according to claim 1, wherein multiple welding seams and/or welding points are applied adjacent to one another.

3. The method according to claim 1, wherein in order to form an elongated region with reduced strength, multiple welding points are applied in a line or an elongated welding seam is applied.

4. The method according to claim 3, wherein on a portion of the body or body part designed as a support, the multiple welding points or the welding seam are arranged around the periphery, or are only arranged in portions around the periphery.

5. The method according to claim 3, wherein the line is straight or curved or angled.

6. A body or body part of a motor vehicle, which is produced in a method according to claim 1.

7. A motor vehicle, comprising a body or a body part according to claim 6.

8. The method according to claim 2, wherein in order to form an elongated region with reduced strength, multiple welding points are applied in a line or an elongated welding seam is applied.

9. The method according to claim 4, wherein the line is straight or curved or angled.
